(19) United States
(12) Patent Application Publication
(10) Pub. No.: US 2013/0062814 A1
(43) Pub. Date: Mar. 14, 2013

(54) INJECTION MOLDING MACHINE AND METHOD FOR MANUFACTURING PRODUCT

(71) Applicants: FANG JIANG, Shenzhen City (CN); FA-YE LI, Shenzhen City (CN); SHUN-BAI WU, Shenzhen City (CN); DAI-PING ZHOU, Shenzhen City (CN); HAO-QUAN WU, Shenzhen City (CN); PENG TAN, Shenzhen City (CN); CUI CHEN, Shenzhen City (CN)

(72) Inventors: FANG JIANG, Shenzhen City (CN); FA-YE LI, Shenzhen City (CN); SHUN-BAI WU, Shenzhen City (CN); DAI-PING ZHOU, Shenzhen City (CN); HAO-QUAN WU, Shenzhen City (CN); PENG TAN, Shenzhen City (CN); CUI CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/490,536

(22) Filed: Jun. 7, 2012

(30) Foreign Application Priority Data
Sep. 14, 2011 (CN) 201110271190.7

(51) Int. Cl. B29C 45/72; B29C 45/40

(52) U.S. Cl. 264/328.14; 425/547

(57) ABSTRACT

A method for manufacturing a product is provided. Inject a molten plastic in a cavity via a channel and a gate of a mold. Form a molten plastic product with a configuration of the cavity. Maintain a preset pressure in the cavity to maintain the configuration of the molten plastic product in the cavity. Slide a dam to into a position of the gate and remove the gate marks from the molten plastic products. Cool and harden the molten plastic product to form a solid product. Release the preset pressure. Move the dam away from the cavity. Eject the solid product out of the cavity.

### BACKGROUND

1. Technical Field

The present disclosure relates to a injection molding machine and a method for manufacturing a product with plastic material.

2. Description of Related Art

In manufacturing a plastic product, a plastic in liquid form is injected in a cavity of a mold. The molten plastic hardens when it is cooled in the cavity to form the product. Excess plastic known as flash may be attached to the product after molding. One such type of flash occurs around the sprue gates and is known as a ‘gate mark’. Gate marks are often manually cut or ground away after the plastic is ejected out of the cavity, which is time-consuming, and risks human error such that the product may be damaged if the gate mark is not removed properly. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an injection molding machine in accordance with an embodiment.

FIG. 2 is a flowchart of a method for manufacturing a product in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

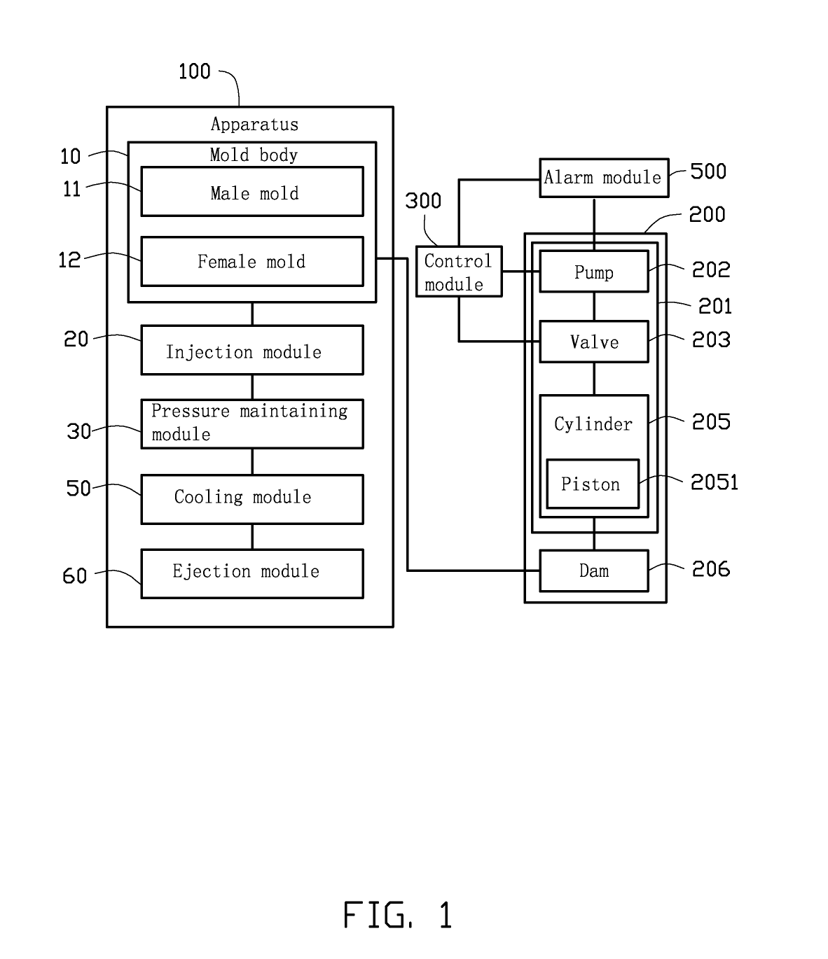

Referring to FIG. 1, an injection molding machine in accordance with an embodiment includes an apparatus 100, a moving mechanism 200, a control module 300, and an alarm module 500.

The apparatus 100 includes a mold body 10, an injection module 20, a pressure maintaining module 30, a cooling module 50, and an ejection module 60.

The mold body 10 includes a male mold 11 and a female mold 12. A plurality of cavities (not shown) is defined in at least one of the male mold 11 and the female mold 12. A channel is defined in at least one of the male mold 11 and the female mold 12, to interconnect the plurality of cavities.

The injection module 20 is configured to inject a molten plastic into the plurality of cavities via the channel.

The cooling module 50 is configured to cool the heated plastic in the plurality of cavities and thereby products are manufactured.

The ejection module 60 is configured to eject the products out of the plurality of cavities.

The moving mechanism 200 includes a driving module 201 and a dam 206. The driving module 201 is configured to move the dam 206. The driving module 201 includes a pump 202, a valve 203, and a cylinder 205. The pump 202 is connected to a liquid source. The cylinder 205 is connected to the pump 202 via the valve 203. The cylinder 205 includes a piston 2051. The dam 206 is secured to the piston 2051.

The liquid source may be, for example, a container with oil, water or other liquid. When the pump 202 works, the liquid in the liquid source is output by the pump 202, and a first pressure is applied to the valve 203. The control module 300 defines a determined pressure applied to the valve 203. When the first pressure is less than the determined pressure, the control module 300 activates the alarm module 500 and the valve 203 is switched off. When the first pressure is greater than or equal to the determined pressure, the control module 300 deactivates the alarm module 500 and the valve 203 is switched on. When the valve 203 is switched on, the liquid is pumped from the liquid source into the cylinder 205 to make the piston 2051 extend out of the cylinder 205. When the valve 203 is switched off, the liquid flows out of the cylinder 205 and back to the liquid source, the piston 2051 retracts into the cylinder 205. The dam 206 is configured to move along the piston 2051 into a position of the gates to conform to a configuration of the molten plastic in the cavity to a configuration of each cavity, thereby preventing formation of gate marks on the molten plastic products.

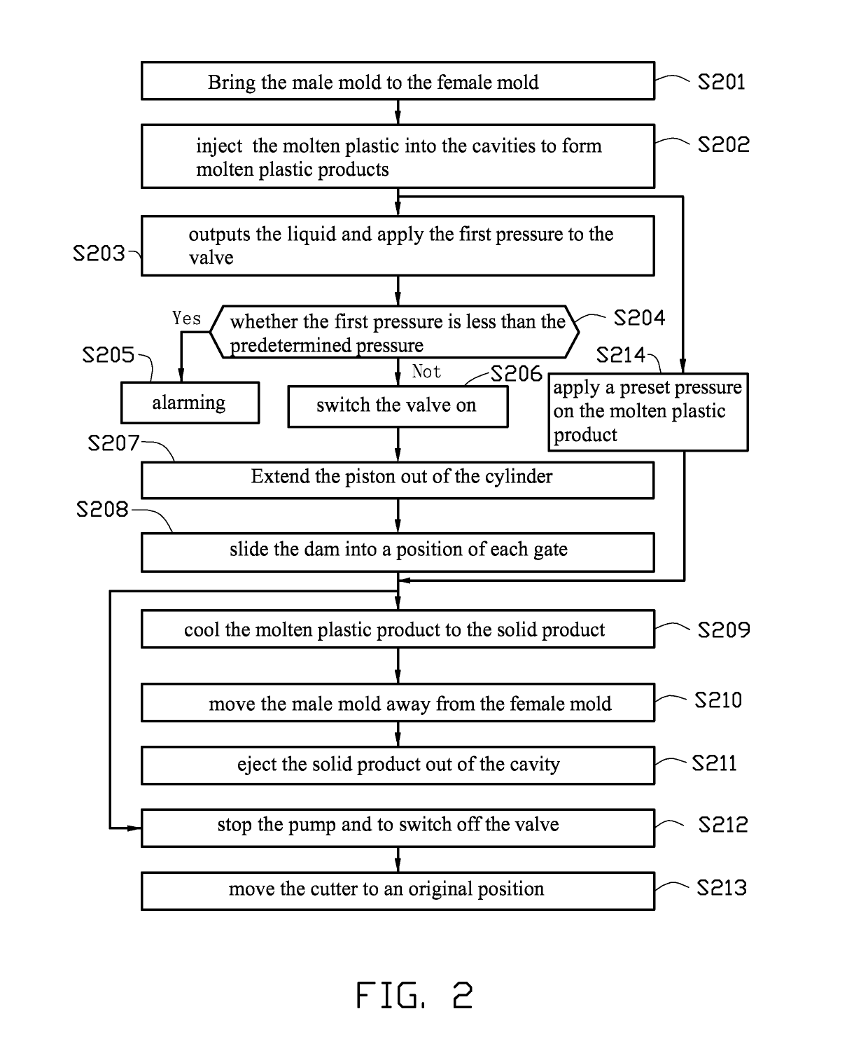

FIG. 2 is a flowchart of an embodiment of a method for manufacturing the products.

In step S201: the male mold 11 and the female mold 12 are brought together.

In step S202: the injection module 20 injects the molten plastic, to flow into the cavities via the channel and gates, and molten plastic product are thereby formed in the cavities each with a configuration of each cavity.

In step S203: the control module 300 activates the pump 202 to output the liquid, and the first pressure is applied to the valve 203.

In step S204: the control module 300 determines whether the first pressure is less than the predetermined pressure; when yes, go to S205; when not, go to S206.

In step S205: the control module 300 activates the alarm module 500.

In step S206: the valve 203 is switched on, and the liquid flows into the cylinder 205.

In step S207: the piston 2051 extends to move the dam 206 to the gates of the molten plastic products.

In step S208: the dam 206 slides into position at the gates to remove the molten plastic in the gate from the molten plastic product, so as to conform a configuration of the molten plastic product to the cavity configuration, thereby preventing formation of gate marks on the molten plastic products.

In step S209: the cooling module 50 cools and hardens the molten plastic products to the solid products with the configurations of the cavities.

In step S210: the male mold 11 is pulled away from the female mold 12.

In step S211: the ejection module 60 ejects the solid product out of the cavity.

After step S202 but before step S209, a step S214 is executed wherein the pressure maintaining module 30 applies a preset pressure on the molten plastic products in the cavity to maintain the shape of the molten plastic products in the mold.

After the step S208, the following steps are also executed:

In step S212: the control module 300 stops the pump 202 and switches off the valve 203, so the liquid flows out of the cylinder 205.

In step S213: the piston 2051 retracts into the cylinder 205, and the dam 206 is moved to an original position.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for manufacturing a product, the method comprising following steps:
injecting a molten plastic in a cavity via a channel and a gate of a mold;
forming a molten plastic product with a configuration;
maintaining a preset pressure in the cavity to maintain the configuration of the molten plastic product in the cavity;
sliding a dam to into a position of the gate to remove the molten plastic in the gate from the molten plastic product, so as to conform the configuration of the molten plastic product to a configuration of the cavity;
cooling and hardening the molten plastic product to form a solid product;
releasing the preset pressure;
moving the dam away from the cavity; and
ejecting the solid product out of the cavity.

2. The method of claim 1, further comprising driving a pump to output a liquid and applying a first pressure to a valve; wherein the driving the pump is done after injecting the molten plastic, but before driving sliding the dam.

3. The method of claim 2, further comprising determining the first pressure is less than a predetermined pressure; when yes, the valve is switched off, the liquid can only flow out from a cylinder, and an alarm module is activated; when no, the valve is switched on, the liquid can only flow into the cylinder, and the alarm module is deactivated.

4. The method of claim 3, wherein a piston of the cylinder extends out of the cylinder when the liquid flows in the cylinder and retracts into the cylinder when the liquid flows out of the cylinder; and the dam is secured to the piston and moveable with the piston.

5. The method of claim 3, further comprising switching off the valve after cutting the gate until the dam is moved to an original position.

6. An injection molding machine for manufacturing a product comprising:
a mold defining a cavity, a channel, and a gate; the channel in communication with the cavity via the gate;
an injection module configured to inject a molten plastic into the cavity;
a moving mechanism, the moving mechanism comprising a dam;
a control module configured to drive the moving mechanism to move the dam between an original position, where the channel is not blocked by the dam, and the molten plastic can flow into the cavity; and a final position, where the dam is located in a position of the gate to block the channel for prevent the molten plastic from moving out of the cavity and to conform a configuration of the molten plastic in the cavity to a configuration of the cavity;
a cooling module configured to cool the molten plastic in the cavity to form a solid product;
a pressure maintaining module configured to maintain a preset pressure in the cavity after the molten plastic flows into the cavity, but before the cooling module cools the molten plastic; and
an ejection module configured to eject the solid product out of the cavity.

7. The injection molding machine of claim 6, wherein the moving mechanism further comprises a pump, a valve, and a cylinder; the cylinder is connected to the pump via the valve; the cylinder comprises a piston; and the dam is secured to the piston.

8. The injection molding machine of claim 7, wherein when the valve is switched off, a liquid can only flow out of the cylinder; and when the valve is switched on, the liquid can only flow into the cylinder.

9. The injection molding machine of claim 8, wherein the control module defines a predetermined pressure and determines whether a first pressure applied to the valve is less than the predetermined pressure when the pump works; when yes, the valve is switched off; when not, the valve is switched on.

10. The injection molding machine of claim 9, further comprising an alarm module, wherein the control module activates the alarm module when the first pressure is less than the predetermined pressure.

11. A method for manufacturing a product, the method comprising following steps:
providing an injection molding machine; wherein the injection molding machine comprises a mold, an injection module, a moving mechanism, a control module, a cooling module, a pressure maintaining module, and an ejection module; the mold defining a cavity, a channel, and a gate; the channel being in communication with the cavity via the gate; and the moving mechanism comprising a dam;
injecting a molten plastic in the cavity via the channel and the gate by the injection module;
forming a molten plastic product with a configuration by the injection module;
maintaining a preset pressure in the cavity to maintain the configuration of the molten plastic product in the cavity by the pressure maintaining module;
sliding the dam to into a position of the gate to remove the molten plastic in the gate from the molten plastic product by the moving mechanism under controlling of the control module, so as to conform the configuration of the molten plastic product to a configuration of the cavity;
cooling and hardening the molten plastic product to form a solid product by the cooling module;
releasing the preset pressure by the pressure maintaining module;
driving the moving mechanism to move the dam away from the cavity the control module; and
ejecting the solid product out of the cavity by the ejection module.

12. The method of claim 11, further comprising the moving mechanism driving a pump to output a liquid and applying a first pressure to a valve; wherein the driving the pump is done after injecting the molten plastic, but before sliding the dam.

13. The method of claim 12, further comprising the control module determining the first pressure is less than a predetermined pressure; when yes, the valve is switched off, the liquid can only flow out from a cylinder, and an alarm module is activated; when no, the valve is switched on, the liquid can only flow into the cylinder, and the alarm module is deactivated.

14. The method of claim 13, wherein a piston of the cylinder extends out of the cylinder when the liquid flows in the cylinder and retracts into the cylinder when the liquid flows out of the cylinder; and the dam is secured to the piston and moveable with the piston.

15. The method of claim 13, further comprising switching off the valve after the dam is moved to an original position.
